(19) United States
(12) Patent Application Publication
(10) Pub. No.: US 2005/0115325 A1
(43) Pub. Date: Jun. 2, 2005

(54) Vibration control system for adjusting the repetition rates of individual vibrators in a pneumatic vibration apparatus

(76) Inventor: Charles F. Felkins, Berthoud, CO (US)

Correspondence Address: Emery L. Tracy, P.O. Box 1518, Boulder, CO, 80306-1518, US

(21) Appl. No.: 10/994,561

(22) Filed: Nov. 22, 2004

Related U.S. Application Data
(60) Provisional application No. 60/524,985, filed on Nov. 25, 2003.

(51) Int. Cl. G01N 29/00

(52) U.S. Cl. 73/665

(57) ABSTRACT

A vibration control system having at least one pneumatic vibrator for vibrating a vibration apparatus is provided. The vibration control system comprises an air manifold having a plurality of varying sized orifices, each pneumatic vibrator fluidly connected to one of the orifices. A method for oscillating pneumatic vibrators at different repetition rates with each pneumatic vibrator secured to a vibration apparatus is also provided.

The present application is a continuation of pending provisional patent application Ser. No. 60/524,985, filed on Nov. 25, 2003, entitled “Means for Adjusting the Repetition Rates of Individual Vibrators in a Pneumatic Vibrations System”.

### BACKGROUND OF THE INVENTION

1. Field of the Invention

This invention relates to shake tables or random vibration apparatus that use pneumatic hammers for stressing other devices. The present invention is intended to smear the frequencies generated by the random vibration apparatus.

2. Description of the Prior Art

In the past, vibration screening of equipments, e.g., electronic and mechanical assemblies, was accomplished by single-axis mechanical vibration apparatus or by electro-dynamic shakers. Multiple axis systems were constructed of multiple single axis systems. These systems were very expensive and required technically skilled personnel to operate. Starting in the late 1980's, pneumatic vibrations systems, such as described in U.S. Pat. No. 4,735,089, were coming into use. These systems were fairly inexpensive to purchase and maintain, and required much less skilled personnel to operate. Another advantage of the pneumatic vibration tables is that they produce six degree's of freedom vibration accelerations, i.e., X-axis, Y-axis, Z axis, roll, pitch and Yaw movements.

One of the problems when using multiple pneumatic vibrators supplied from a single air source, is that they will all run (vibrate) at the same frequency (repetition rate). This will produce a line spectrum, i.e., the fundamental frequency of the vibrator, followed by all of the related harmonics. In screening test products, it is desirable to excite the product under test with a continuous spectrum, thus ensuring that the product is subjected to all frequencies within the selected range. The result of not having a continuous spectrum may result in excessive excitation occurring at the fundamental or harmonic frequencies which may destroy the product, or in not finding or precipitating flaws in the device under test due to lack of energy being supplied at the activation frequency needed to produce a resonance.

Various means have been used to produce continuous spectrums. U.S. Pat. No. 4,181,025 utilizes adjustable valves, which control individual orifices in the airlines to each vibrator. U.S. Pat. No. 5,493,944 utilizes a dual piston within each vibrator, with one piston being controlled and the other left to randomly oscillate between first piston and the end of the cylinder. U.S. Pat. No. 5,365,788 utilizes a vibrator housing that creates an angular path for the input airflow that changes the piston stroke length as the piston rotates. U.S. Pat. No. 4,164,151 utilizes a plurality of loose projectiles (balls) within cavities of a chamber (vibration table), that when excited by external vibration energy, causes the balls to bounce around their individual chambers in a random fashion.

Each of these methods produces a somewhat random spectrum, but each also has its drawbacks. The first listed is expensive to implement, requiring an excessive amount of hardware. The third method has problems with the individual vibrators syncing up in frequency, and creating wild vibration level changes. The fourth requires projectiles of vary large mass to create any useful vibration levels. The second is inexpensive, but due to internal characteristics, produces less energy than standard vibrators and looses effectiveness if used with other standard pneumatic vibrators.

Other methods that have been used include; using multiple vibrators of different sizes, that run at different repetition rates, using manually adjustable valves inline with each vibrator and amplitude modulation of the electrical current-to-pressure valve used to control the overall vibration level. Using multiple dissimilar vibrators does create multiple frequencies that will tend to fill in the spectrum, but using different size vibrators will also create different energy levels at each attachment point, making the levels vary across the table.

Using manually adjustable valves to adjust the frequency of each vibrator, is almost impossible to do accurately, as the changes in orifice sizes needed to produce acceptable results is in the order of 5-10 thousandths for each vibrator. In the last case, modulating the control to all of the vibrators simultaneously will also change the overall vibration level, making control at the desired level difficult.

Accordingly, there exists a need for a vibration control system wherein the repetition rate of the enclosed piston in pneumatic vibrators is directly proportional to its supplied air pressure. Additionally, a need exists for a vibration control system wherein all pneumatic vibrators utilized in a pneumatic vibration system oscillate at different repetition rates. Furthermore, there exists a need for a vibration control system wherein the air pressures to each vibrator used in a pneumatic vibration system are altered via an air manifold that uses multiple orifice sizes, calculated to make each vibrator run at a slightly different rate.

### SUMMARY

The present invention is a vibration control system having at least one pneumatic vibrator for vibrating a vibration apparatus is provided. The vibration control system comprises an air manifold having a plurality of varying sized orifices, each pneumatic vibrator fluidly connected to one of the orifices.

Additionally, the present invention is a method for oscillating pneumatic vibrators at different repetition rates. Each pneumatic vibrator is secured to a vibration apparatus. The method comprises providing an air manifold having a plurality of varying sized orifices and fluidly connecting each pneumatic vibrator to one of the orifices.

The present invention further includes a vibration control device system having at least one pneumatic vibrator for vibrating a vibration apparatus. The vibration control device comprises means for oscillating each pneumatic vibrator at different repetition rates.

### BRIEF DESCRIPTION OF THE DRAWINGS

FIG. 1 is an exploded top view illustrating the assembly of the vibration control unit, constructed in accordance with the present invention;

FIG. 2 is an exploded perspective view illustrating the assembly of the vibration control unit, constructed in accordance with the present invention;

FIG. 3 is an elevational side view illustrating the assembly of the vibration control unit, constructed in accordance with the present invention;

FIG. 4 is a top plan view illustrating the assembly of the vibration control unit, constructed in accordance with the present invention;

FIG. 5 is an end view illustrating the assembly of the vibration control unit, constructed in accordance with the present invention;

FIG. 6 is a perspective view of the variable port manifold, constructed in accordance with the present invention;

FIG. 7 is an exploded perspective view illustrating the vibration table, constructed in accordance with the present invention;

FIG. 8 is an exploded perspective view illustrating the pneumatic hammer, constructed in accordance with the present invention;

FIG. 9 is a graph illustrating the spectrum with a standard manifold; and

FIG. 10 is a graph illustrating the spectrum with the modified manifold.

### DETAILED DESCRIPTION OF THE PREFERRED EMBODIMENTS

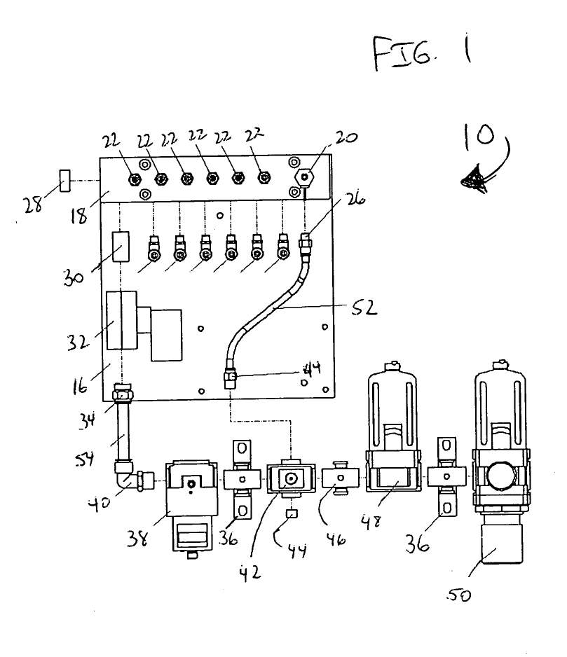

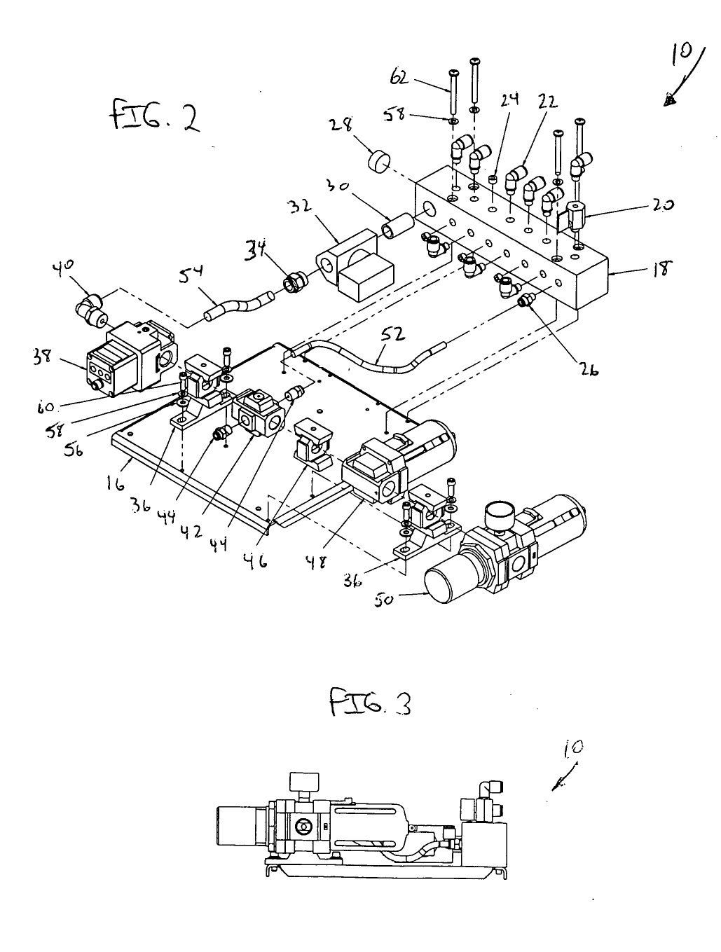

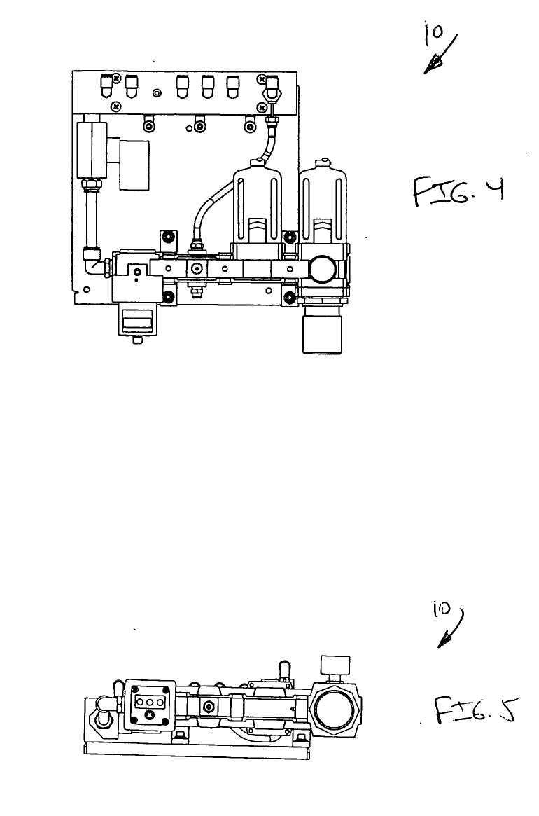

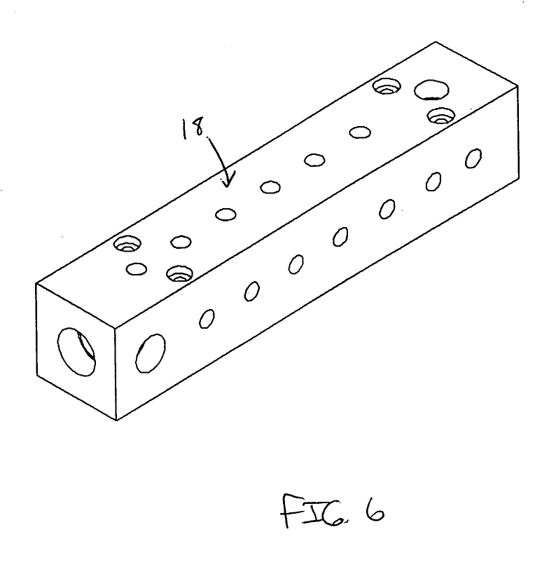

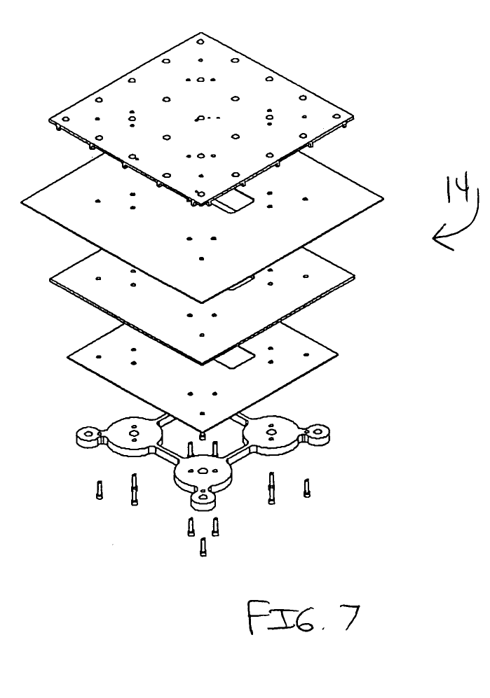

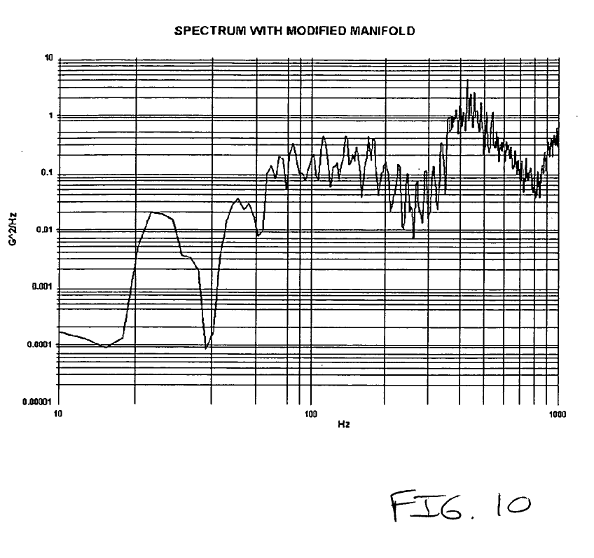

There is general concern in the industry concerning generating a continuous spectrum. As illustrated in FIGS. 1-10, the present invention is a vibration control system, indicated generally at 10, and method of generating a continuous spectrum that is both predictable and controlled.

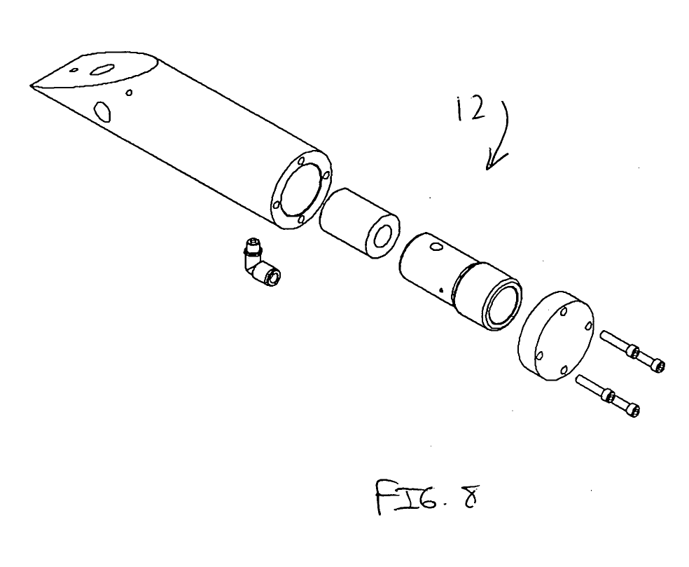

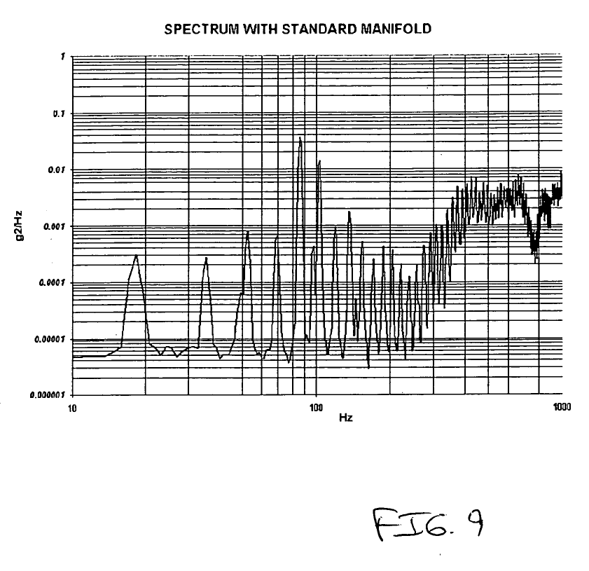

The vibration control system 10 includes the following parts connected to a pneumatic vibrator 12 (FIG. 8) for use with a vibrator apparatus 14 (FIG. 7):

| Item | | |
|---|---|---|
| No. | Quantity | Description |
| 16 | 1 | Panel, Pneumatics Mounting, OVS - 1.5/2.5 |
| 18 | 1 | Manifold, Pneumatics, OVS 2.5 Manifold 12 |
| 20 | 1 | Valve, Ball Type, M-FM, ⅛″ NPT |
| 22 | 9 | Fitting, Male Elbow, 5/16″ Tube, ⅛″ NPT |
| 24 | 4 | Plug, Countersink, Hex, ⅛″ NPT |
| 26 | 1 | Fitting, Male Conn., ¼″ Tube, ⅛″ NPT |
| 28 | 1 | Fitting, Plug, CS SKT Head, ¾″ NPT |
| 30 | 1 | Fitting, Hex Nipple, ½″ NPT |
| 32 | 1 | Valve, Solenoid, ½″ NPT |
| 34 | 1 | Fitting, M Con, ½″ Tube, ½″ NPT |
| 36 | 2 | Fitting, Space with T Bracket, ½″ |
| 38 | 1 | Regulator, E-P, 30 Series, 24 V, 1/2″ NPT, with STR |
| | | Cable |
| 40 | 1 | Fitting, Male Elbow, ½″ Tube, ½″ NPT |
| 42 | 1 | Cross Spacer, ½″, ¼″ NPT, with 2 Plugs |
| 44 | 2 | Fitting, Male Conn., ¼″ Tube, ¼″ NPT |
| 46 | 1 | Fitting, Spacer, ½″ |
| 48 | 1 | Mist Separator, 4000 Series, ½″ NPT |
| 50 | 1 | Filter/Regulator, 4000 Series, ½″ NPT, with Gauge |
| 52 | 1 | Nylon Tubing, ¼″ OD, 9″ long |
| 54 | 1 | Nylon Tubing, ½″ OD, 4″ long |
| 56 | 4 | Washer, ¼″, Flat, SS |
| 58 | 8 | Washer, ¼″, Split Lock, SS |
| 60 | 4 | Screw, ¼-20 × ¾″, SHCS, SS |
| 62 | 4 | Screw, ¼-20 × 2.5″, PPMS, SS |

It will be understood by those persons skilled in the art that the parts of the vibration control system 10 listed above are representative only and that other equivalent parts are within the scope of the present invention.

The vibration control system 10 of the present invention entails use of compressed air that passes through the air filters, an air regulator, a current to pressure regulator, and a solenoid valve. The vibration control system 10 controls the air pressure that is fed into the variable port manifold 18 having a plurality of ports 22. Each port 22 formed in the manifold 18 feeds the tubing that connects to each pneumatic vibrator 12. The vibrators 12 are attached to the underside of the-vibration apparatus 14, as known in the art.

In the present invention, the pneumatic manifold 18 has multiple output ports 22 (as many as needed for the system being implemented). Each succeeding port 22 has a smaller orifice than the preceding port. Regardless of the overall air pressure, with the varying size multiple output ports 22, each pneumatic vibrator 12 will continue to run at a different frequency. In actual implementation, it is desirable that the multiple orifices or ports 22 selected be such that the fundamental frequency of the highest frequency vibrator 12 be close to the first harmonic of the fundamental frequency of the lowest frequency vibrator 12, thereby ensuring a substantially continuous spectrum.

It follows that the repetition rate of the enclosed piston in the pneumatic vibrators 12 is directly proportional to its supplied air pressure. The vibration control system 10 of the present invention ensures that all the pneumatic vibrators 12 utilized in the pneumatic vibration control system 10 oscillate at different repetition rates. The air pressure to each vibrator 12 used in the vibration control system 10 is altered via the air manifold that uses multiple orifice 22 sizes, calculated to make each vibrator 12 run at a slightly different rate. As the repetition rate of the vibrator 12 is directly proportional to air pressure, the lower the air pressure, the lower the repetition rate.

Augmenting the above spectrum is a condition know as “heterodyning”, i.e., two fundamental frequencies will produce an additional frequency that is the difference between the two original fundamental frequencies. For example, a frequency of fifteen (15) Hz and another of twenty (20) Hz will produce a difference frequency of five (5) Hz. With multiple separated vibration frequencies being generated at all times, multiple heterodyne frequencies are also generated, which also aids in filling in the spectrum. The vibration platform (table) has its own multi-modal structural vibrational modes, which also fill in and shape the spectrum.

In sum, random vibration is used to precipitate defects from a product or assembly. It is desirable for the energy at each frequency to have substantially the same order of magnitude thereby increasing the likelihood of forcing latent defects to be captured by the screen. Holes in the frequency spectrum allow defects that would be excited in that frequency range to escape. With each vibrator 12 running at a different frequency, the frequency spectrum is less likely to have gaps and/or peaks, and be better able to capture defect in the product under test.

The present invention utilizes a different size orifice 22 for each vibrator 12 or set of vibrators 12 thereby allowing each vibrator 12 to run at a different frequency. The orifice 22 can be machined in a single manifold 18 for cost effectiveness. The vibrator frequencies are stable and, therefore, easy to control. The orifice size can be optimized for each vibrator 12 and vibrator location on the table allowing for very tight control of the frequency range generated.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

1. A vibration control system having at least one pneumatic vibrator for vibrating a vibration apparatus, the vibration control system comprising:
an air manifold having a plurality of varying sized orifices, each pneumatic vibrator fluidly connected to one of the orifices.

2. The vibration control system of claim 1 wherein each succeeding orifice has a smaller diameter than the preceding orifice such that the varying size orifices cause each pneumatic vibrator to run at a different frequency.

3. The vibration control system of claim 1 wherein the sizes of the orifices are selected such that the fundamental frequency of the highest frequency pneumatic vibrator has a harmonic approximately equal to the first harmonic of the fundamental frequency of the lowest frequency vibrator thereby ensuring a substantially continuous spectrum.

4. The vibration control system of claim 1 wherein each pneumatic vibrator oscillates at different repetition rates.

5. The vibration control system of claim 4 wherein air pressure to each pneumatic vibrator is altered via the air manifold causing each pneumatic vibrator to operate at a different rate.

6. The vibration control system of claim 1 and further comprising:
tubing connected between each orifice and each pneumatic vibrator.

7. The vibration control system of claim 1 and further comprising:
compressed air;
at least one air filter connected to the compressed air;
an air regulator connected to the air filter;
a current to pressure regulator connected to the air regulator; and
a solenoid valve connected to the current to pressure regulator.

8. The vibration control system of claim 7 wherein the air pressure fed into the air manifold is controlled.

9. The vibration control system of claim 1 wherein each pneumatic vibrator has an enclosed piston, the repetition rate of the enclosed piston being directly proportional to its supplied air pressure.

10. A method for oscillating pneumatic vibrators at different repetition-rates, each pneumatic vibrator secured to a vibration apparatus, the method comprising:
providing an air manifold having a plurality of varying sized orifices; and
fluidly connecting each pneumatic vibrator to one of the orifices.

11. The method of claim 10 wherein each succeeding orifice has a smaller diameter than the preceding orifice such that the varying size orifices cause each pneumatic vibrator to run at a different frequency.

12. The method of claim 10 and further comprising:
selecting the sizes of the orifices such that the fundamental frequency of the highest frequency pneumatic vibrator has a harmonic approximately equal to the first harmonic of the fundamental frequency of the lowest frequency vibrator thereby ensuring a substantially continuous spectrum.

13. The method of claim 10 and further comprising:
altering the air pressure to each pneumatic vibrator via the air manifold causing each pneumatic vibrator to operate at a different rate.

14. The method of claim 10 and further comprising:
connecting tubing between each orifice and each pneumatic vibrator.

15. The method of claim 10 and further comprising:
providing compressed air;
connecting at least one air filter to the compressed air;
connecting an air regulator to the air filter;
connecting a current to pressure regulator to the air regulator; and
connecting a solenoid valve to the current to pressure regulator.

16. The method of claim 15 and further comprising:
controlling the air pressure fed into the air manifold.

17. The method of claim 10 wherein each pneumatic vibrator has an enclosed piston, the repetition rate of the enclosed piston being directly proportional to its supplied air pressure.

18. A vibration control device system having at least one pneumatic vibrator for vibrating a vibration apparatus, the vibration control device comprising:
means for oscillating each pneumatic vibrator at different repetition rates.

19. The vibration control device of claim 18 wherein the oscillating means includes an air manifold having a plurality of varying sized orifices, each pneumatic vibrator fluidly connected to one of the orifices.

20. The vibration control device of claim 19 wherein each succeeding orifice has a smaller diameter than the preceding orifice such that the varying size orifices cause each pneumatic vibrator to run at a different frequency.
